(19) United States
(12) Patent Application Publication
(10) Pub. No.: US 2021/0084563 A1
(43) Pub. Date: Mar. 18, 2021

(54) ELECTRONIC APPARATUS, SYSTEM, AND SERVER

(71) Applicant: KABUSHIKI KAISHA TOSHIBA, Tokyo (JP)

(72) Inventors: Miyuki OGURA, Tachikawa Tokyo (JP); Tatsuma HIRANO, Kawasaki Kanagawa (JP)

(73) Assignee: KABUSHIKI KAISHA TOSHIBA, Tokyo (JP)

(21) Appl. No.: 16/807,664

(22) Filed: Mar. 3, 2020

(30) Foreign Application Priority Data
Sep. 13, 2019 (JP) 2019-167624

(51) Int. Cl. H04W 40/20; H04B 7/155; H04L 12/741

(52) U.S. Cl. CPC H04W 40/20; H04W 88/16; H04L 45/745; H04B 7/155

(57) ABSTRACT

According to one embodiment, an electronic apparatus includes processor circuitry and transmission circuitry. The processor circuitry is configured to acquire information regarding a movement direction and a movement speed of the electronic apparatus, information regarding a movement direction and a movement speed of the first wireless relay apparatus, and information regarding a movement direction and a movement speed of the second wireless relay apparatus, select a relay destination of data from the first wireless relay apparatus and the second wireless relay apparatus based on the movement direction and the movement speed of the electronic apparatus, the first wireless relay apparatus, and the second wireless relay apparatus.

### CROSS-REFERENCE TO RELATED APPLICATIONS

This application is based upon and claims the benefit of priority from Japanese Patent Application No. 2019-167624, filed Sep. 13, 2019, the entire contents of which are incorporated herein by reference.

### FIELD

Embodiments described herein relate generally to an electronic apparatus, a system, and a server.

### BACKGROUND

In recent years, techniques related to Internet of Things (IoT) are widely known, and in such techniques, data measured by sensors (nodes), that is, sensor data are transmitted to a server through a wireless network. The server collects a vast amount of sensor data to be used for various purposes.

The sensor data may be transmitted to the server through, for example, a wireless mesh network including a plurality of electronic apparatuses which will be referred to as wireless relay apparatuses.

Note that, in a case where the wireless mesh network is formed, each wireless relay apparatus must select a relay destination of the sensor data (other wireless relay apparatus), and if a sensor and a wireless relay apparatus are disposed in a mobile object, the wireless nesh network may possibly become unstable.

### BRIEF DESCRIPTION OF THE DRAWINGS

FIG. 1 is a diagram illustrating the structure of an IoT communication system of an embodiment.

FIG. 2 is a diagram illustrating data delivery in an upstream direction.

FIG. 3 is a diagram illustrating data delivery in a downstream direction.

FIG. 4 is a diagram illustrating an example of an address table.

FIG. 5 is a diagram illustrating an example of a hardware structure of a wireless relay apparatus.

FIG. 6 is a block diagram illustrating an example of a functional structure of the wireless relay apparatus.

FIG. 7 is a diagram illustrating an example of signal formats handled by the wireless relay apparatus.

FIG. 8 is a diagram illustrating an outline of the operation of the wireless relay apparatus when a relay destination is set in a routing table.

FIG. 9 is a diagram illustrating an outline of the operation of the wireless relay apparatus when a relay destination is set in a routing table.

FIG. 10 is a sequence chart illustrating an example of a process of setting a relay destination in an upstream direction in a routing table in a wireless relay apparatus.

FIG. 11 is a diagram illustrating an example of the data structure of object information included in a DIO message.

FIG. 12 is a diagram for explaining a wireless relay apparatus set in a routing table as a relay destination in an upstream direction.

FIG. 13 is a flowchart illustrating an example of a process performed when a relay destination in a downstream direction is set in a routing table in a wireless relay apparatus.

FIG. 14 is a diagram for explaining a wireless relay apparatus set in a routing table as a relay destination in a downstream direction.

FIG. 15 is a diagram illustrating an example of a functional structure of a server.

FIG. 16 is a flowchart illustrating an example of a process performed by the server when reselection of a route is instructed.

### DETAILED DESCRIPTION

In general, according to one embodiment, an electronic apparatus configured to communicate with a first wireless relay apparatus and a second wireless relay apparatus includes processor circuitry and transmission circuitry. The processor circuitry is configured to acquire information regarding a movement direction and a movement speed of the electronic apparatus, acquire information regarding a movement direction and a movement speed of the first wireless relay apparatus, acquire information regarding a movement direction and a movement speed of the second wireless relay apparatus, select a relay destination of data from the first wireless relay apparatus and the second wireless relay apparatus based on the movement direction and the movement speed of the electronic apparatus, the movement direction and the movement speed of the first wireless relay apparatus, and the movement direction and the movement speed of the second wireless relay apparatus. The transmission circuitry is configured to transmit the data to selected one of the first wireless relay apparatus and the second wireless relay apparatus.

Various embodiments will be described hereinafter with reference to the accompanying drawings.

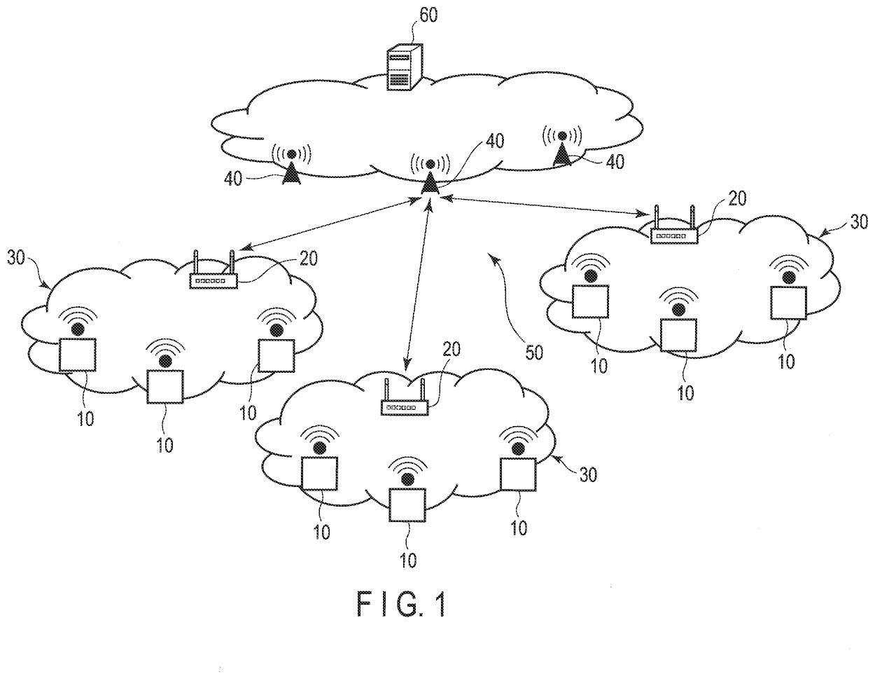

Initially, the structure of an Internet of Things (IoT) communication system of the present embodiment will be explained with reference to FIG. 1. The IoT communication system of FIG. 1 is configured such that a server can collect data measured by various sensors (nodes) disposed in a mobile object which is movable (the data will be referred to as sensor data) through a wireless relay apparatus (electronic apparatus), gateway, and fixed wireless apparatus. Furthermore, the IoT communication system is configured such that the server can control various sensors through the fixed wireless apparatus, gateway, and wireless relay apparatus.

Note that, in the present embodiment, the mobile object may be, for example, a train, automobile, or drone, and may be other mobile objects (for example, a mobile robot).

As in FIG. 1, the IoT communication system includes a first wireless network 30 including (structured with) a plurality of wireless relay apparatuses 10 and at least one gateway 20. Each of the wireless relay apparatuses 10 is connected to a corresponding sensor (which is not shown) such that sensor data measured by the sensor can be acquired. Note that a correspondence relationship between a wireless relay apparatus 10 and a sensor may be one-to-one or may be one-to-many.

In the present embodiment, the first wireless network 30 is a wireless mesh network, and each of the wireless relay apparatuses 10 generates a wireless frame suitable for the first wireless network 30 (hereinafter referred to as first wireless frame), and transmits the first wireless frame to a peripheral wireless relay apparatus 10 or a gateway 20 through a certain wireless method (wireless communication method). Furthermore, each of the wireless relay apparatuses 10 receives the first wireless frame generated by the peripheral wireless relay apparatus 10 or the gateway 20, and transmits the first wireless frame to a different wireless relay apparatus 10 or a different gateway 20.

The gateway 20 transmits/receives the first wireless frame to/from the wireless relay apparatuses 10 of the first wireless network 30 through the first wireless network 30.

Here, in the present embodiment, the wireless relay apparatuses 10 and the gateway 20 of one first wireless network 30 are disposed in the same mobile object (a train or the like). Specifically, in the present embodiment, the wireless relay apparatuses 10 and sensors are provided with various devices and facilities such as air conditioners, motors, and inverters of each car of a train, and sensor data measured by the sensors are collected by the server.

In that case, in the IoT communication system of the present embodiment, a plurality of first wireless networks 30 may be formed in each train.

Furthermore, the IoT communication system further includes a second wireless network 50 including a plurality of gateways 20 forming each first wireless network 30 and fixed wireless apparatuses (fixed communication apparatuses) 40.

The second wireless network 50 is, for example, a cellular network (of 3G or 4G), and the gateway 20 detects a fixed wireless apparatus 40 which performs the wireless communication service and issues a connection request to a suitable fixed wireless apparatus 40. Furthermore, the gateway 20 generates a wireless frame suitable for the second wireless network 50 (hereinafter referred to as second wireless frame), and transmits the second wireless frame to the fixed wireless apparatus 40 through a certain wireless method. Furthermore, the gateway 20 receives the second wireless frame generated by the fixed wireless apparatus 40.

The fixed wireless apparatus 40 has a certain radio wave service area to constantly receive a connection request from the gateway 20 within the radio wave service area, establishes a session necessary for the communication with the gateway 20, and transmits/receives the second wireless frame to/from the gateway 20. Furthermore, the fixed wireless apparatus 40 transmits/receives an Ethernet (registered trademark) frame to/from a server 60 disposed on the Internet or an intranet through a device within a core network (which is not shown). Note that the fixed wireless apparatus 40 and the server 60 are connected through a wire.

The server 60 collects the sensor data measured by the above-mentioned various sensors through the first wireless network 30 and the second wireless network 50 according to the application program operated on the server 60. Furthermore, the server 60 may transmit application control data to the wireless relay apparatuses 10 connected to the various sensors to control the operation of the sensors.

Hereinafter, an outline of the operation of the IoT communication system of the present embodiment will be explained. Initially, data delivery in an upstream direction (direction from the wireless relay apparatus 10 to the server 60) will be explained.

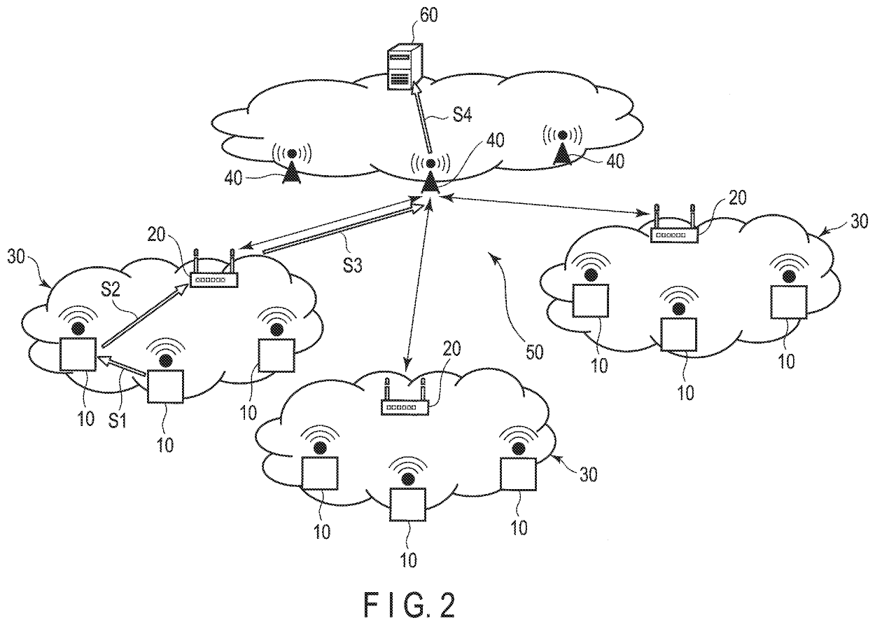

As in FIG. 2, when a wireless relay apparatus (hereinafter referred to as first wireless relay apparatus) 10 acquires sensor data measured by sensors connected thereto, a first wireless frame storing the sensor data in a data field is generated in the first wireless relay apparatus 10. The first wireless frame generated in the first wireless relay apparatus 10 is transmitted to a different wireless relay apparatus 10 (hereinafter referred to as second wireless relay apparatus) which forms the same first wireless network 30 including the first wireless relay apparatus 10 (step S1).

Then, the second wireless relay apparatus 10 generates a first wireless frame storing both sensor data stored in the data field of the first wireless frame transmitted from the first wireless relay apparatus 10 and sensor data measured by the sensors connected to the second wireless relay apparatus 10 in a data field. The first wireless frame generated in the second wireless relay apparatus 10 is transmitted to the gateway 20 which forms the same first wireless network 30 including the second wireless relay apparatus 10 (and the first wireless relay apparatus 10) (step S2).

The gateway 20 receives the first wireless frame transmitted from the second wireless relay apparatus 10. Furthermore, the gateway 20 can receive the first wireless frame transmitted from a wireless relay apparatus 10 different from the second wireless relay apparatus 10 (a different wireless relay apparatus 10 forming the first wireless network including the second wireless relay apparatus 10). The gateway 20 sequentially stores (buffers) sensor data stored in the data field of each received first wireless frame in a buffer which is operable from the gateway 20. Thus, the gateway 20 collects sensor data (hereinafter referred to as first sensor data group) measured by the sensors connected to each of the wireless relay apparatuses 10 forming the first wireless network 30.

The gateway 20 takes data of necessary size (bytes) from the collected (buffered) first sensor data group in accordance with a preset (programmed) procedure, and generates a second wireless frame storing the data in the data field. The second wireless frame generated in the gateway 20 is transmitted to the fixed wireless apparatus 40 from the gateway 20 (step S3).

The fixed wireless apparatus 40 receives the second wireless frame from the gateways 20 forming the second wireless network 50 (within a radio wave service area), and transmits Ethernet-framed sensor data to the server 60 through a wired network through a device in the core network (which is not shown) (step S4).

The sensor data transmitted from the fixed wireless apparatus 40 to the server 60 (sensor data measured by the sensors) are processed in the server 60 to be, for example, converted, analyzed, and associated with data, and used in creation of advanced techniques and services.

Thus, in the IoT communication system of the present embodiment, widely-scattered sensor data can be collected by the server 60 on the Internet, and services using IoT can be provided.

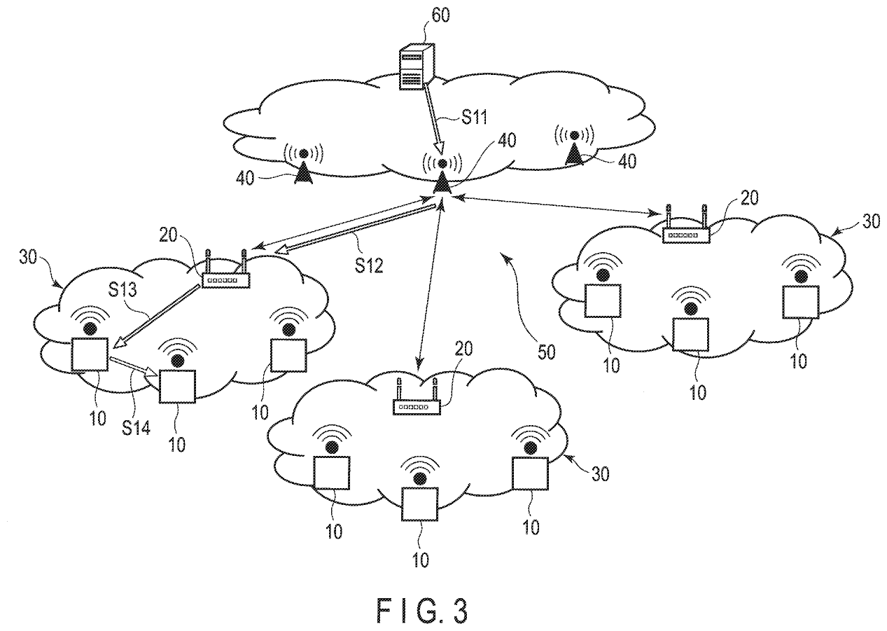

Now, data delivery in a downstream direction (direction from the server 60 to the wireless relay apparatus 10) will be explained with reference to FIG. 3.

In the present embodiment, there may be a case where, if a request to control an operation of a specific wireless relay apparatus 10 (sensor corresponding thereto) (hereinafter referred to as control request) may occur by processing the collected sensor data in the server 60 as explained above with reference to FIG. 2, contents of the control request will be instructed from the server 60 to the specific wireless relay apparatus 10. In that case, application control data to which the contents of the control request are reflected are transmitted from the server 60 to the wireless relay apparatus 10.

Here, in the above-mentioned second wireless network 50, a fixed wireless apparatus 40 to be connected to the gateway 20 forming the first wireless network 30 to which the first wireless relay apparatus 10 (delivery destination of application control data) attributes from a plurality of fixed wireless apparatuses 40.

As the second wireless network 50, a public network such as Long Term Evolution (LTE) operated by a telecommunication service provider may be used. In that case, the second wireless network 50 includes a wireless access network including a plurality of terminal apparatuses and a plurality of base stations and a core network which performs communication control of base stations in response to access requests from the terminal stations.

The core network receives a connection request from a terminal station which is associated with a subscriber identifier of the terminal station, performs the communication control for a base station to be connected to the terminal station, and manages the communication conditions of a certain base station group including the connection-destination base station and the terminal station. Furthermore, if a distribution request of data with respect to a specific terminal station occurs, the core network distributes paging data with respect to the base station group corresponding to the terminal station. The paging data are distributed in a multicast manner from all base stations in the base station group based on a certain method, and upon detection of paging data addressed thereto, a terminal station selects one base station from the base station group and transmits a connection request thereto. In the core network, communication control corresponding to the connection request is performed between the terminal station which is a sender of the connection request and the base station selected by the terminal station. As above, in the core network side, from which base station a terminal station including a specific subscriber identifier sends a connection request can be recognized.

In the distribution of application control data in the present embodiment is performed using the above-mentioned mechanism. Note that, in the present embodiment, the above-mentioned terminal station corresponds to the gateway 20, and the base station corresponds to the fixed wireless apparatus 40.

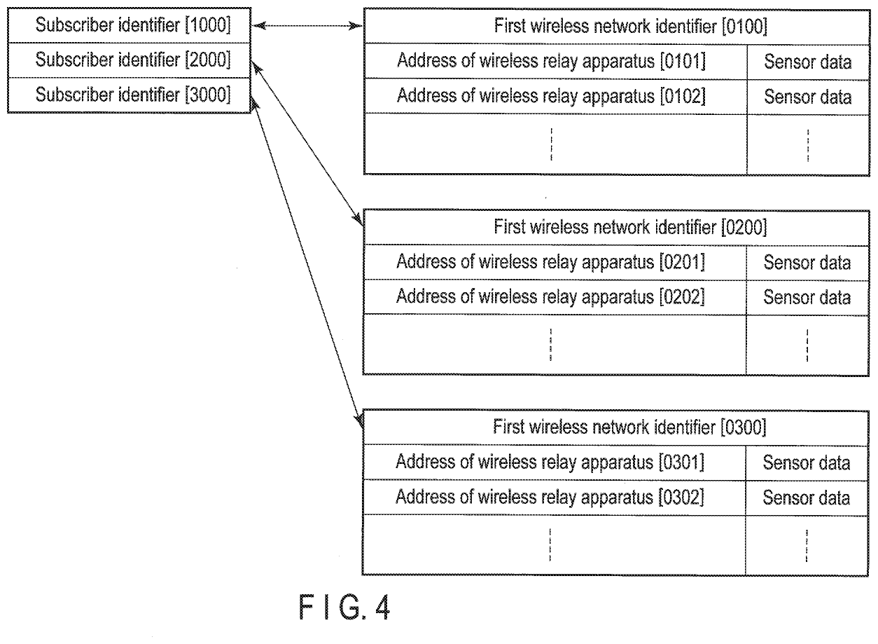

In that case, the server 60 includes an address table shown in FIG. 4. Note that the address table may be included in a data base (not shown) to which the server 60 can access.

As in FIG. 4, in the address table, for example, address 0101 of the first wireless relay apparatus 10 and address 0102 of the second wireless relay apparatus 10 are stored to be associated with identifier 0100 of the first wireless network 30 (that is, first wireless network including the first and second wireless relay apparatuses 10). Furthermore, in the address table, identifier 0100 of the first wireless network 30 is stored to be associated with subscriber identifier 1000 of the gateway 20 forming the first wireless network 30.

In this example, the first wireless network 30 including the first and second wireless relay apparatuses 10 is explained, and the same applies to other first wireless networks 30, that is, an identifier of the first wireless network 30 (address of wireless relay apparatuses 10 of the first wireless network) and a subscriber identifier of a gateway 20 of the first wireless network 30 are associated with each other and stored in the address table.

Note that the identifier of the first wireless network 30 stored in the address table is a variable which can be associated with a gateway 20 forming the first wireless network 30 (for example, an address or a number), and is assigned by an application program operable on the server 60 (IoT communication system), for example.

Here, if a control request with respect to, for example, the first wireless relay apparatus 10 occurs, the server 60 generates application control data to which the contents of the control request are reflected, and generates an Ethernet frame storing the application control data in the data field.

Then, the server 60 detects a subscriber identifier of the gateway 20 associated with the address of the first wireless relay apparatus 10 (identifier of the first wireless network 30 associated therewith) from the address table, and transmits an Ethernet frame. A device (not shown) in the core network receiving the Ethernet frame detects a fixed wireless apparatus 40 to be connected to the gateway 20 using the above-mentioned paging data (paging procedure).

Then, the Ethernet frame generated in the server 60 as above is transmitted to the gateway 20 in a frame format corresponding to the method of the core network, and the detected fixed wireless apparatus 40 receives the Ethernet frame (step S11). The fixed wireless apparatus 40 converts the received Ethernet frame into the second wireless frame to transmit the second wireless frame to the gateway 20 (step S12).

When the gateway 20 receives the second wireless frame, the second wireless frame is converted into a first wireless frame. In that case, the application control data are stored in the data field of the first wireless frame. The first wireless frame which is converted from the second wireless frame in the gateway 20 is transmitted from the gateway 20 to the second wireless relay apparatus 10 (step S13).

Then, the second wireless relay apparatus 10 relays (transmits) the first wireless frame transmitted from the gateway 20 to the first wireless relay apparatus 10 (step S14).

When the first wireless frame is received by the first wireless relay apparatus 10, the first wireless relay apparatus 10 takes the application control data stored in the data field of the first wireless frame. The application control data include control data with respect to the sensors connected to the first wireless relay apparatus 10, and the sensors operate in accordance with the control data (that is, perform a certain application operation).

Through the above steps, in the IoT communication system of the present embodiment, the control with respect to certain sensors of widely-scattered sensors can be performed based on, for example, collected sensor data, and services using the IoT can be provided.

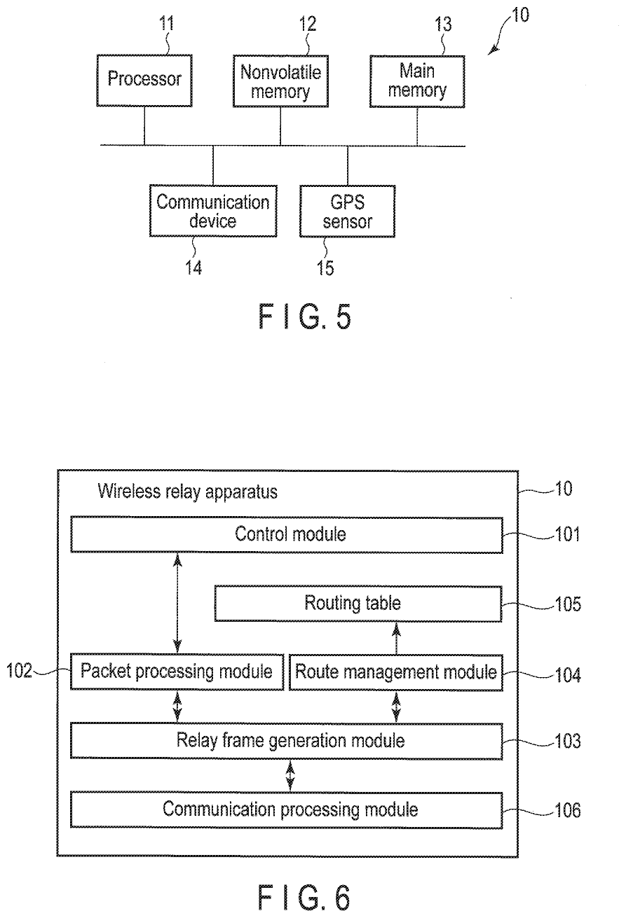

Now, the structure of a wireless relay apparatus (electronic apparatus) 10 of the present embodiment will be explained. FIG. 5 illustrates an example of the hardware structure of the wireless relay apparatus 10. As in FIG. 5, the wireless relay apparatus 10 includes, for example, a processor 11, a nonvolatile memory 12, a main memory 13, a communication device 14, and a global positioning system (GPS) sensor 15.

The processor 11 is a hardware processor (processor circuitry) to control operations of each component in the wireless relay apparatus 10. The processor 11 executes programs loaded from the nonvolatile memory 12 which is a storage device to the main memory 13. Note that the processor of the wireless relay apparatus 10 may be, for example, a CPU or another controller.

The communication device 14 (transmission circuitry and reception circuitry) is a device configured to execute wireless communication with, for example, a different wireless relay apparatus 10 and a gateway 20, and includes, for example, a wireless LAN adopter.

The GPS sensor 15 is a sensor which can detect a position of the wireless relay apparatus 10 by communicating with a GPS satellite.

FIG. 6 is a block diagram illustrating an example of the functional structure of the wireless relay apparatus 10. As in FIG. 6, the wireless relay apparatus 10 includes a control module 101, a packet processing module 102, a relay frame generation module 103, a route management module 104, a routing table 105, and a communication processing module 106.

In the present embodiment, all or a part of the control module 101, the packet processing module 102, the relay frame generation module 103, the route management module 104, and the communication processing module 106 may be implemented by causing the processor 11 to execute a certain program, that is, by software. Note that all or a part of the modules 101 to 104, and 106 may be implemented by a hardware such as integrated circuit (IC), or may be implemented as a combination of software and hardware.

Furthermore, in the present embodiment, the routing table 105 is stored in the nonvolatile memory 12 or the like.

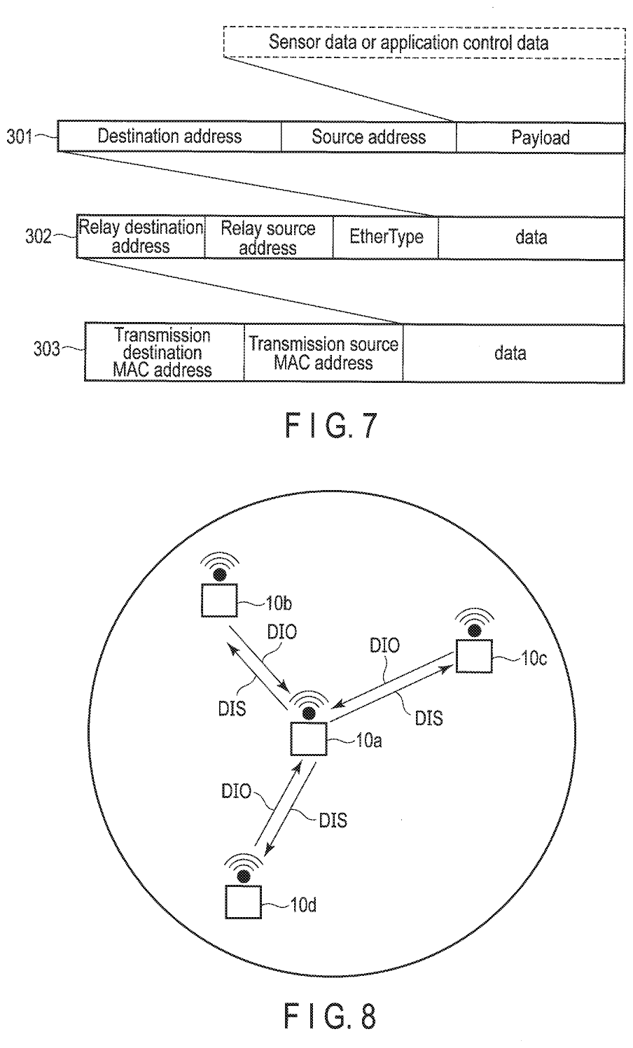

Hereinafter, the operation of the wireless relay apparatus 10 of the present embodiment will be explained with reference to FIG. 6. In this example, first to third operations will be mainly explained. In the following explanation, the wireless relay apparatus 10 which performs the first to third operations will be referred to as target wireless relay apparatus 10. Note that FIG. 7 illustrate an example of signal formats handled by the target wireless relay apparatus 10 in the first to third operations to be explained below.

Firstly, a first operation will be explained. The first operation is an operation performed by the target wireless relay apparatus 10 when the sensor data measured by corresponding sensors are acquired.

In the first operation, the control module 101 of FIG. 6 acquires sensor data from corresponding sensors (that is, sensors connected to the target wireless relay apparatus 10) through a certain interface using in a general computer. Note that the certain interface may be, for example, a wired interface such as USB, PCI Express, SATA, or a wireless interface such as Bluetooth (registered trademark). The control module 101 reports the acquired sensor data to the packet processing module 102.

The packet processing module 102 receives a report from the control module 101 and generates an internet protocol (IP) packet 103 of FIG. 7. In the IP packet 301, an IP address of the server 60 is set in a destination address of a header field, IP address of the target wireless relay apparatus 10 is set in the source address of the header field, and sensor data are set in a payload field. Note that, the IP packet 301 generated by the packet processing module 102 is reported to the relay frame generation module 103.

The relay frame generation module 103 receives a report from the packet processing module 102 and generates a wireless relay frame 302 of FIG. 7 referring to the routing table 105 through the route management module 104. In the wireless relay frame 302, a link address of a different wireless relay apparatus 10 which is a relay destination is set in a relay destination address of a header field, and a link address of the target wireless relay apparatus 10 is set in a relay source address of the header field. Furthermore, in the wireless relay frame 302, a protocol identifier used in application communication (in this example, communication of sensor data and application control data) is set in an EtherType of the header field. Furthermore, in the wireless relay frame 302, the IP packet described above is stored in the data field. Note that the wireless relay frame 302 generated by the relay frame generation module 103 is reported to the communication processing module 106.

Note that, although details of the routing table 105 will be described later, in the routing table 105, a link address of the wireless relay apparatus 10 which is a relay destination of sensor data in transmitting the senor data to an upstream direction (that is, a relay destination in the upstream direction) and a link address of the wireless relay apparatus 10 which is a relay destination of application control data in transmitting the application control data to a downstream direction (that is, a relay destination in the downstream direction).

Furthermore, the link addresses are addresses set according to virtual addresses used for a route management (relay management) handled by the route management module 104, and they may be IP addresses or MAC addresses.

The communication processing module 106 receives a report from the relay frame generation module 103 and generates a first wireless frame in accordance with a certain wireless method to which the communication processing module 106 (communication device 14) conforms. Specifically, if the communication processing module 106 uses a wireless method conforming to IEEE 802.11, for example, the communication processing module 106 generates first wireless frame 303 in which a MAC address of the wireless relay apparatus 10 which is a relay destination is set in a transmission destination MAC address of the header field, a MAC address of the target wireless relay apparatus 10 (communication device 14) is set in the transmission source MAC address of the header field, and the wireless relay frame is set in the data field. The first wireless frame 303 generated in the communication processing module 106 is transmitted to a different wireless relay apparatus 10 which is a relay destination in the upstream direction through an antenna (which is not shown) of the communication device 14, for example.

Through the first operation, the target wireless relay apparatus 10 can transmit the sensor data measured by corresponding sensors to a different wireless relay apparatus 10 (relay destination) through certain wireless communication.

In this example, a case where the target wireless relay apparatus 10 transmits sensor data to a different wireless relay apparatus 10 has been explained; however, the sensor data may be transmitted to a gateway 20 depending on the settings of the routing table 105.

Now, a second operation will be explained. The second operation is an operation performed by the target wireless relay apparatus 10 when receiving the first wireless frame 303 generated in a different relay apparatus 10. In this example, a case where the target wireless relay apparatus 10 receives the first wireless frame 303 including sensor data measured by the sensors connected to a different wireless relay apparatus 10 or application control data with respect to a different relay apparatus 10 (sensors connected thereto) will be considered. Note that, in the first wireless frame 303 including the application control data, the application control data are set in the payload field of the IP packet 301.

In the second operation, when the communication processing module 106 receives a first wireless frame 303 from a different wireless relay apparatus 10, the communication processing module 106 reports the data field of the first wireless frame 303 (that is, wireless relay frame 302) to the relay frame generation module 103.

The relay frame generation module 103 refers to an EtherType set in the wireless relay frame 302 (data field of the first wireless frame 303) reported from the communication processing module 106, and if the IP packet 301 stored in the data field of the wireless relay frame 302 is for the purpose of application communication, the relay frame generation module 103 reports the IP packet 301 to the packet processing module 102.

The packet processing module 102 refers to a destination address in a header field of the IP packet 301 reported from the relay frame generation module 103 to determine whether the IP packet 301 is an IP packet addressed to the target wireless relay apparatus 10 or is an IP packet to be relayed to a different wireless relay apparatus 10. That is, the packet processing module 102 determines that the IP packet 301 should be relayed to a different wireless relay apparatus 10 if the IP address set in the destination address is other than the IP address of the target wireless relay apparatus 10, and reports the result to the relay frame generation module 103.

When receiving the report from the packet processing module 102, the relay frame generation module 103 refers to the routing table 105 through the route management module 104 and generates a wireless relay frame 302. In the wireless relay frame 302, a link address of the wireless relay apparatus 10 to be a relay destination is set in a relay destination address of a header field, link address of the target wireless relay apparatus 10 is set in a source address of the header field, and protocol identifier used in application communication is set in EtherType of the header field. Furthermore, in the wireless relay frame 302, the IP packet 301 is stored in a data field. Note that the wireless relay frame 302 generated by the relay frame generation module 103 is reported to the communication processing module 106.

When receiving the report from the relay frame generation module 103, the communication processing module 106 generates a first wireless frame in accordance with a certain wireless method to which the communication processing module 106 (communication device 14) conforms. In the first wireless frame 303, a MAC address of the wireless relay apparatus 10 which is a relay destination is set in a transmission destination MAC address of a header field, MAC address of the target wireless relay apparatus 10 (communication device 14) is set in a transmission source MAC address in the header field, and a wireless relay frame 302 is set in a data field. The first wireless frame 303 generated by the communication processing module 106 is transmitted to a different wireless relay apparatus 10 which is a relay destination through an antenna of the communication device 14.

Through the second operation, the target wireless relay apparatus 10 can relay sensor data acquired by a different relay apparatus 10 or application control data with respect to a different wireless relay apparatus 10 (can perform relay transfer through a multi hop method).

In this example, a case where the target wireless relay apparatus 10 receives a first wireless frame from a different wireless relay apparatus 10 has been explained, and the same applies to a case where the target wireless relay apparatus 10 receives a first wireless frame from a gateway 20. Furthermore, in this example, a case where the target wireless relay apparatus 10 transmits a first wireless frame to a different wireless relay apparatus 10 has been explained, and the first wireless frame may be transmitted to a gateway 20 depending on the settings of the routing table 105.

Now, a third operation will be explained. The third operation is an operation performed by the target wireless relay apparatus 10 when receiving a first wireless frame 303 generated by a different wireless relay apparatus 10, and it is different from the second operation because the target wireless relay apparatus 10 receives a first wireless frame 303 including application control data with respect to the target wireless relay apparatus 10 (sensors connected thereto).

In the third operation, the communication processing module 106 receives a first wireless frame 303 from a different wireless relay apparatus 10, and reports a data field of the first wireless frame 303 (that is, wireless relay frame 302) to the relay frame generation module 103.

The relay frame generation module 103 refers to an EtherType set in the wireless relay frame 302 (data field of the first wireless frame 303) reported from the communication processing module 106, and if recognizes that the IP packet 301 stored in the data field of the wireless relay frame 302 is for the purpose of application communication, reports the IP packet 301 to the packet processing module 102.

The packet processing module 102 refers to a destination address in the header field of the IP packet 301 reported from the relay frame generation module 103 to determine whether the IP packet 301 is an IP packet addressed to the target wireless relay apparatus 10 or the IP packet to be relayed to a different wireless relay apparatus 10. That is, the packet processing module 102 determines that the IP packet 301 is addressed to the target wireless relay apparatus 10 if the IP address set in the destination address is the IP address of the target wireless relay apparatus 10, and reports the IP packet 301 to the control module 101.

The control module 101 takes the application control data set in the data field (payload field) of the IP packet 301 reported from the packet processing module 102, and transmits the application control data to the sensors connected to the target wireless relay apparatus 10 using a predetermined interface.

Through the third operation, the target wireless relay apparatus 10 can control the operation of corresponding sensors (sensors to which the target wireless relay apparatus 10 is connected) based on the application control data addressed to the target wireless relay apparatus 10.

As described above, the relay destination of the first wireless frame transmitted by the wireless relay apparatus 10 (a link address of a different wireless relay apparatus 10 which is to be the relay destination) is set in the routing table 105; however, if the relay destination is not set properly, relaying of the first wireless frame may not be performed smoothly, and the first wireless network 30 formed by the wireless relay apparatus 10 may become unstable.

Specifically, in the present embodiment, as described above, a case where the wireless relay apparatuses 10 and the gateway 20 forming one first wireless network 30 are disposed in the same mobile object (for example, a train) or a plurality of mobile objects which move in cooperation (for example, drones) is considered.

Now, a case where a link address of a wireless relay apparatus 10 disposed in a second train which is different from a first train is set as a relay destination in the routing table 105 of the wireless relay apparatus 10 disposed in the first train will be considered. In general, as a relay destination of data to be transmitted from a wireless relay apparatus 10 (sensor data or application control data), a different wireless relay apparatus 10 which is in the proximity of the wireless relay apparatus 10 can be selected in many cases in consideration of a communication condition or the like with the wireless relay apparatus 10. Thus, if the first train and the second train pass each other, the wireless relay apparatus 10 disposed in the second train may be selected as the relay destination of the data (first wireless frame) transmitted from the wireless relay apparatus 10 disposed in the first train.

In such a case, there is no problem if the first train and the second train are within the proximity; however, if the first train is distant from the second train as running away, the wireless relay apparatus 10 disposed in the first train cannot perform communication with the wireless relay apparatus (disposed in the second train) 10 which is set as the relay destination, and must reselect a different wireless relay apparatus 10 which is a new relay destination (that is, must prepare the routing table 105 again). If such selection of the relay destination (route selection) occurs frequently, the first wireless network 30 may become unstable.

In this example, trains are used as an example, and the same possibility of unstableness in the first wireless network 30 applies to a case where first wireless networks 30 are formed in an area where mobile objects such as cars or drones with the wireless relay apparatuses 10 exist with high density.

Thus, the wireless relay apparatus 10 of the present embodiment suitably selects a relay destination which avoids the above-mentioned frequent route selection (a different wireless relay apparatus 10 for that purpose) and sets the selected relay destination in the routing table 105.

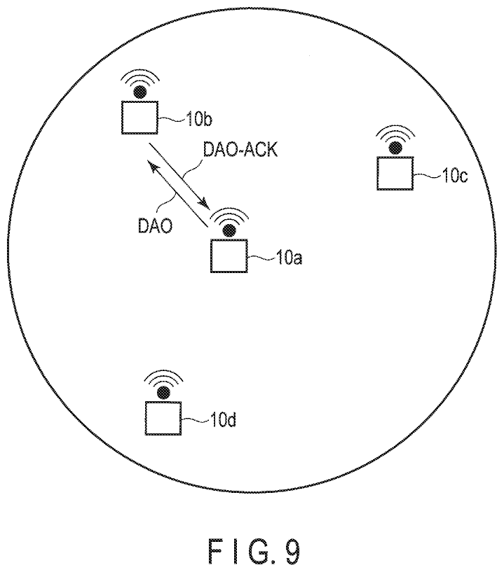

Now, an outline of the operation of the wireless relay apparatus 10 when setting a relay destination in the routing table 105 will be explained with reference to FIGS. 8 and 9. In this example, a case where a relay destination in the upstream direction is set will be explained. Note that the setting (generation) of the routing table 105 is performed, for example, at the time when the wireless relay apparatus 10 forms a first wireless network 30.

In FIGS. 8 and 9, a case where a wireless relay apparatus 10a forms a first wireless network 30 (that is, firstly connects to the first wireless network 30) and wireless relay apparatus 10b to 10d exist in the periphery of the wireless relay apparatus 10a will be explained. Furthermore, the wireless relay apparatuses 10b and 10c are already connected to the first wireless network 30, and the wireless relay apparatus 10d is unconnected to the first wireless network 30 as with the wireless relay apparatus 10a.

Now, if the wireless relay apparatus 10a forms the first wireless network 30 in the present embodiment, a wireless relay frame is transmitted/received between the wireless relay apparatus 10a and the wireless relay apparatuses 10b to 10d. In that case, a signal format of the wireless relay frame is the same as the example of FIG. 7, and a protocol identifier IP packet of which is used in the communication for the route management is set in EtherType included in a header field of the wireless relay frame. Furthermore, in the data field of the wireless relay frame, a route control message is set.

Note that the setting of the routing table 105 is performed by the route management module 104, and the routing table 105 is set in accordance with the above-described route control message. In that case, the route management module 104 operates conforming to a routing protocol such as Ipv6 Routing Protocol for Low Power and Lossy Networks (RPL, routing protocol conforming to RFC6550).

Specifically, the route control message handled by RPL includes, for example, DODAG Information Solicitation (DIS), DODAG Information Object (DIO), and Destination Advertisement Object (DAO). A DIS message corresponds to an inquiry message transmitted by the wireless relay apparatus 10a to the peripheral wireless relay apparatuses 10b to 10d when connecting to the first wireless network 30. A DIO message is a reply message transmitted from each of the wireless relay apparatuses 10b to 10d to the DIS message transmitted from the wireless relay apparatus 10a. A DAO message is a message returned to a relay destination determined based on the DIO message transmitted from each of the wireless relay apparatuses 10b to 10d.

That is, in the present embodiment, if the wireless relay apparatus 10a forms the first wireless network 30, for example, the wireless relay apparatus 10a transmits a DIS message to the peripheral wireless relay apparatuses (wireless relay apparatuses 10b to 10d in the example of FIG. 8), and receives a DIO message from each of the wireless relay apparatuses 10b to 10d in reply to the DIS message. Furthermore, if the wireless relay apparatus 10a selects, for example, the wireless relay apparatus 10b as a relay destination based on each received DIO message, the wireless relay apparatus 10a transmits a DAO message with respect to the wireless relay apparatus 10b and receives a DAO-ACK message from the wireless relay apparatus 10b as in FIG. 9. In that case, in the routing table 105 of the wireless relay apparatus 10a, a link address of the wireless relay apparatus 10b is set as the relay destination. Note that, the wireless relay apparatus 10b in that case is a relay destination in the upstream direction of the first wireless frame transmitted from the wireless relay apparatus 10a.

Now, an example of a process performed when a relay destination in the upstream direction of the wireless relay apparatus 10a is set in the routing table 105 will be explained with reference to a sequence chart of FIG. 10.

Initially, if the wireless relay apparatus 10a connects to the first wireless network 30 for the first time, the route management module 104 generates a DIS message (step S21). The DIS message generated in step S21 is reported to the relay frame generation module 103.

Upon receipt of the report from the route management module 104, the relay frame generation module 103 refers to the routing table 105 while no link address is set (does not exist) in the routing table 105 since the wireless relay apparatus 10a connects to the first wireless network 30 for the first time. Thus, the relay frame generation module 103 generates wireless relay frame in which a multicast address is set in a relay destination address in a header field, protocol identifier (protocol identifier of RPL in this example) used in a route management communication is set in an EtherType of the header field, and the DIS message is set in a data field. The wireless relay frame is reported to the communication processing module 106.

Since the multicast address is set in the relay destination address of the header field of the wireless relay frame reported from the relay frame generation module 103, the communication processing module 106 transmits the wireless relay frame to the wireless relay apparatuses 10b to 10d in accordance with a certain wireless method to which the communication processing module 106 conforms (steps S22 to S24). Specifically, if the communication processing module 106 uses a wireless method conforming to, for example, IEEE 802.11, the communication processing module 106 generates probe request frame in which MAC addresses of the wireless relay apparatuses 10b to 10d which are relay destination candidates are set in a transmission destination MAC address of the header field, MAC address of the wireless relay apparatus 10a is set in a transmission source of the header field, and the wireless relay frame is set in an empty field of the header, and transmits the probe request frame to the wireless relay apparatuses 10b to 10d.

In this example, a probe request frame is used as a signal format used in the transmission of the wireless relay frame in which the DIS message is set (a format different from the first wireless frame), and instead of the probe request frame, a probe response frame may be transmitted, for example. Furthermore, the signal format used in the transmission of the wireless relay frame is a signal format by which wireless LAN nodes which are not associated with each other can be exchanged.

When step S22 is performed, the wireless relay apparatus 10b receives a probe request frame transmitted in step S22, and the route management module 104 included in the wireless relay apparatus 10b generates a DIO message (step S25). The DIO message generated in step S25 is reported to the relay frame generation module 103.

Here, in the DIO message of the present embodiment, object information necessary for the selection of a relay destination (that is, to perform the route selection) in the wireless relay apparatus 10a are included.

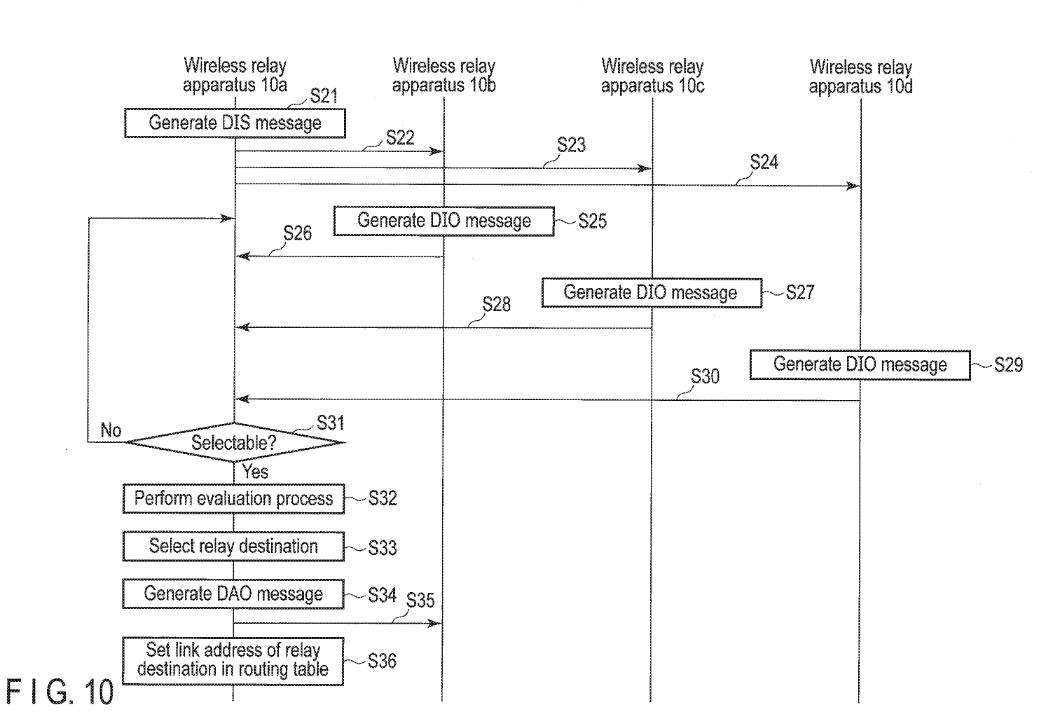

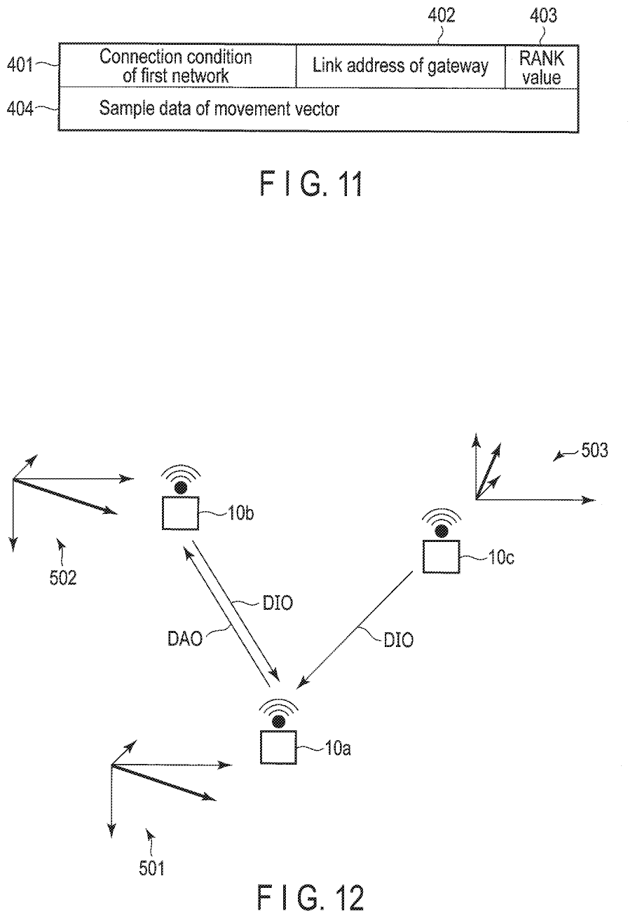

FIG. 11 illustrates an example of the data structure of object information included in the DIO message. As in FIG. 11, the object information includes a connection condition of the wireless relay apparatus 10b with the first wireless network 30 (connected or disconnected), link address of gateway 20 to form the first wireless network 30 to which the wireless relay apparatus 10b is connected (that is, formed by the wireless relay apparatus 10b), RANK value which is an indication of the number of relays (hops) of the wireless relay apparatus 10b from the gateway 20, and sample data of movement vector of the wireless relay apparatus 10b.

Note that the sample data of the movement vector includes positional information (sampling information) indicative of a position (latitude, altitude, and height) in a horizontal surface and a perpendicular surface of the wireless relay apparatus 10b detected by a GPS sensor 15 of the wireless relay apparatus 10b. Specifically, for example, an output from the GPS sensor 15 is sampled at a certain time, and the sampled latitude, altitude, and height (positional information) are associated with the time to acquire the sample data of the movement vector. Note that the sample data of the movement vector is acquired for several times to obtain data corresponding to a variable direction and a variable amount of the movement vector.

Now, as in FIG. 10, the relay frame generation module 103 receives the report from the route management module 104, and generates wireless relay frame in which a link address of the wireless relay apparatus 10a is set in a relay destination address of the header field, link address of the wireless relay apparatus 10b is set in a source address of the header field, protocol identifier (protocol identifier of RPL in this example) used in a route management communication is set in an EtherType of the header field, and the DIO message is set in the data field.

Since the link address of the wireless relay apparatus 10a is set in the relay destination address of the header field of the wireless relay frame reported from the relay frame generation module 103, the communication processing module 106 generates probe response frame in which a MAC address of the wireless relay apparatus 10a is set in the transmission destination MAC address of the header field, MAC address of the wireless relay apparatus 10b is set in the transmission source MAC address of the header field, and the wireless relay frame is set in the empty field of the header, and transmits the probe response frame to the wireless relay apparatus 10a (step S26).

In this example, steps S25 and S26 executed by the wireless relay apparatus 10b are explained, and steps S27 and S28 corresponding to steps S25 and S26 are executed by the wireless relay apparatus 10c, and steps S29 and S30 corresponding to steps S25 and S26 are executed by the wireless relay apparatus 10d.

Through the above steps, the wireless relay apparatus 10a receives the probe response frame transmitted from each of the wireless relay apparatuses 10b to 10d. In that case, in the wireless relay apparatus 10a, the DIO message is taken from the received probe response frame. In the following explanation, it is assumed that the DIO message (probe response frame) is received from each of the wireless relay apparatuses 10b to 10d.

The route management module 104 included in the wireless relay apparatus 10a evaluates the DIO message received from each of the wireless relay apparatuses 10b to 10d, and selects a relay destination in the upstream direction from the wireless relay apparatuses 10b to 10d.

Here, the DIO message is periodically transmitted to the wireless relay apparatus 10a from the wireless relay apparatuses 10b to 10d. Thus, the route management module 104 determines whether or not a DIO message which can be used in the selection of relay destination is received from the wireless relay apparatuses 10b to 10d (that is, whether or not a relay destination is selectable) (step S31). In other words, the DIO message includes sample data of the movement vector, and the route management module 104 determines whether or not the sample data (the number thereof) is sufficient for the selection (evaluation) of the relay destination. Note that the process of step S31 may be performed to determine whether or not a DIO message of high credibility is received based on the signal strength or the like of the DIO messages received from the wireless relay apparatuses 10b to 10d.

If it is determined that the relay destination is not selectable (NO in step S31), the wireless relay apparatus 10a waits for receiving the DIO message again.

On the other hand, if it is determined that the relay destination is selectable (YES in step S31), the route management module 104 executes an evaluation process with respect to the wireless relay apparatuses 10b to 10d to select the relay destination (step S32). Note that the wireless relay apparatus 10d is not connected to the first wireless network 30 at this point of time, and the evaluation process is executed with respect to the wireless relay apparatuses 10b and 10c. Whether or not each of the wireless relay apparatuses 10b to 10d is connected to the first wireless network 30 can be determined based on a connection condition to the first wireless network 30 of object information included in the DIO message received from each of the wireless relay apparatuses 10b to 10d.

In the evaluation process, the router management module 104 calculates a movement direction and a movement speed of the wireless relay apparatus 10a (hereinafter will be referred to as movement vector of the wireless relay apparatus 10a) based on preliminarily-sampled positional data (variable direction and variable amount thereof) indicative of the wireless relay apparatus 10a. Note that, in the present embodiment, the movement direction and the movement speed may be values directly indicative of such movement direction and movement speed, or may be values (coded values) or the like representing a certain range of such movement direction and movement speed. Specifically, the movement speed may be a value such as 10 km/h, or may be represented as 1 which corresponds to a range of 0 to 5 km/h and as 2 which corresponds to a range of 5 to 10 km/h. That is, the movement direction and the movement speed of the present embodiment may be information by which such movement direction and movement speed can be grasped (information regarding movement direction and movement speed).

Furthermore, the route management module 104 acquires several sample data of movement vector from object information included in each of DIO messages received from the wireless relay apparatus 10b. The sample data of movement vector are positional information indicative of, for example, a position of wireless relay apparatus 10b as mentioned above, and the route management module 104 calculates the movement direction and the movement speed of the wireless relay apparatus 10b (hereinafter, will be referred to as movement vector of wireless relay apparatus 10b) based on the positional information (variable direction and variable amount thereof).

Similarly, the route management module 104 acquires several sample data (positional data) of movement vector from the object information included in each of DIO messages received from the wireless relay apparatus 10c, and calculates the movement direction and the movement speed of the wireless relay apparatus 10c (hereinafter will be referred to as movement vector of wireless relay apparatus 10c) based on the positional information (variable direction and variable amount thereof).

Then, the route management module 104 compares the movement vector of wireless relay apparatus 10a and the movement vector of each of the wireless relay apparatuses 10b and 10c. Specifically, the route management module 104 calculates similarity between the movement vector of wireless relay apparatus 10a and the movement vector of wireless relay apparatus 10b. Similarly, the route manger 104 calculates a similarity between the movement vector of wireless relay apparatus 10a and the movement vector of wireless relay apparatus 10c.

Through the above calculation, the route management module 104 selects the wireless relay apparatus 10b or 10c having higher similarity (that is, higher relativity) with the movement vector of the wireless relay apparatus 10a as a relay destination (step S34).

That is, in a case where the wireless relay apparatuses 10 and the gateway 20 forming one first wireless network 30 are set in the same mobile object or mobile objects which move in cooperation, it is estimated that the wireless relay apparatuses having high relativity of movement vector are disposed in the same mobile object or mobile objects which move in cooperation. Thus, in the present embodiment, through selecting a wireless relay apparatus 10 having high relativity of movement vector as a relay destination, selecting a wireless relay apparatus 10 disposed in a different mobile object (that is, a wireless relay apparatus 10 forming a different first wireless network 30) as a relay destination can be avoided.

Note that the similarity calculated in step S32 may be, for example, a correlation coefficient or a degree of approximation.

Furthermore, in this example, the movement vector of the wireless relay apparatuses 10a to 10c is an absolute value of the movement direction and the movement speed (information generated based thereon), and for example, movement vector of the wireless relay apparatuses 10b and 10c may be calculated as a relative value of movement direction and movement speed with respect to the movement direction and the movement speed of the wireless relay apparatus 10a (information generated based thereon), and a relay destination may be selected based on the movement vector of the wireless relay apparatuses 10b and 10c. Note that at least one of the movement vector (movement direction and movement speed) of the wireless relay apparatuses 10a to 10c may be information generated based on an absolute value of movement direction and movement speed, or may be information generated based on a relative value of movement direction and movement speed.

When step S33 is executed, the route management module 104 generates a DAO message (step S34). The DAO message generated in step S34 is reported to the relay frame generation module 103.

If the wireless relay apparatus 10b is selected in step S33, for example, the relay frame generation module 103 generates wireless relay frame in which a link address of the wireless relay apparatus 10b is set in a relay destination address, link address of the wireless relay apparatus 10a is set in a relay source address, protocol identifier used in a route management communication is set in EtherType of a header field (protocol identifier of RPL in this example), and the DAO message is set in a data field. The wireless relay frame is reported to the communication processing module 106.

The communication processing module 106 transmits the first wireless frame including a MAC address of the wireless relay apparatus 10b in a transmission destination address of a header field, MAC address of the wireless relay apparatus 10a in a transmission source address of the header field, and wireless relay frame reported from the relay frame generation module 103 in a data field to the wireless relay apparatus 10b (step S35).

Note that, when step S35 is executed, the route management module 104 sets the link address of the wireless relay apparatus 10b as a relay destination in the upstream direction to the routing table 105 (step S36). In this example, step 36 is executed after step S35; however, step 36 may be executed between steps S33 and S34, for example.

In FIG. 10, the wireless relay frame in which the DAO message is set is transmitted to be wireless relay apparatus 10b, and note that a message other than the DAO message may be used, and especially, if a routing protocol other than RPL is used, a message exchanged between the wireless relay apparatuses 10 for connection request may be used.

Now, the wireless relay apparatus 10 to be set in the routing table 105 as the above-mentioned relay destination will be explained with reference to FIG. 12.

If the wireless relay apparatus 10a connects to the first wireless network 30 for the first time, the wireless relay apparatus 10a receives a DIO message from the wireless relay apparatus 10b, and calculates a movement vector 502 of the wireless relay apparatus 10b based on object information (positional information) included in the DIO message. Similarly, the wireless relay apparatus 10a receives the DIO message from the wireless relay apparatus 10c and calculates the movement vector 503 of the wireless relay apparatus 10c based on the object information (positional information) included in the DIO message.

In this example, based on the positional information detected by the wireless relay apparatuses 10b and 10c, the wireless relay apparatus 10a calculates movement vectors of the wireless relay apparatuses 10b and 10c. However, the wireless relay apparatus 10b (and the wireless relay apparatus 10c) may calculate its movement vector, and may send the calculated movement vector to the wireless relay apparatus 10a as object information of the DIO message.

The wireless relay apparatus 10a compares a movement vector 501 of the wireless relay apparatus 10a with a movement vector 502 of the wireless relay apparatus 10b and a movement vector 503 of the wireless relay apparatus 10c.

In the example of FIG. 12, for example, the movement vector 501 of the wireless relay apparatus 10a is more similar to the movement vector 502 of the wireless relay apparatus 10b than the movement vector 503 of the wireless relay apparatus 10c. In that case, the wireless relay apparatus 10a selects the wireless relay apparatus 10b as a relay destination in the upstream direction.

When the wireless relay apparatus 10b is selected as the relay destination in the upstream direction, the wireless relay apparatus 10a transmits a DAO message to the wireless relay apparatus 10b and sets a link address of the wireless relay apparatus 10b in the routing table 105.

Through the above process, the wireless relay apparatus 10a exchanges a route control message with peripheral wireless relay apparatuses 10b to 10d to set the relay destination in the upstream direction in the routing table 105.

Note that, if the wireless relay apparatus 10b is selected as a relay destination in the upstream direction of data transmitted from the wireless relay apparatus 10a, the wireless relay apparatuses 10a and 10b form the same first wireless network while the wireless relay apparatus 10c which is not selected as the relay destination (that is, the wireless relay apparatus 10c movement direction and movement speed of which are different from those of the wireless relay apparatus 10a) may form a different first wireless network 30 with other wireless relay apparatuses 10.

In this example, the wireless relay apparatus 10b is selected as the relay destination in the upstream direction of data transmitted from the wireless relay apparatus 10a; however, a gateway 20 may be selected as the relay destination in the upstream direction.

Note that, in the present embodiment, a DIO message including object information is transmitted, and the object information may be included in a related message other than the DIO message, and if a routing protocol other than RPL is used, for example, the object information may be included in a message exchanged between the wireless relay apparatuses 10 for the route selection.

Furthermore, in the present embodiment, the wireless relay apparatus 10a selects a relay destination based on DIO messages (object information) received from the wireless relay apparatuses 10b and 10c, and for example, the relay destination may be selected by further using DIO messages transmitted from other wireless relay apparatuses 10 and the like which are relay destinations in the upstream direction of data transmitted from the wireless relay apparatuses 10b and 10c (that is, object relay destinations of multiple levels).

Furthermore, in the present embodiment, sample data of movement vector included in object information include positional information indicative of positions detected by GPS sensors 15, and the sample data including such positional information may be acquired by using sensor devices other than GPS sensors (for example, altimeter or the like).

Here, if the wireless relay apparatuses 10a to 10d of the present embodiment are disposed in mobile objects running on a predetermined route, for example, trains (railways) or cars, a change of distance between the wireless relay apparatus 10a and the wireless relay apparatuses 10b to 10d may be replaced with the above-mentioned movement vector (sample data thereof). Specifically, the wireless relay apparatus 10a transmits a signal to which a transmission time is added, the wireless relay apparatuses 10b and 10d sample a time of receiving the transmitted signal (hereinafter referred to as first reception time), and object information including the sampled first reception time are transmitted to the wireless relay apparatus 10a from each of the wireless relay apparatuses 10b to 10d. Thus, the wireless relay apparatus 10a acquires the transmission time and the first reception time (hereinafter referred to as time sample) for several times from each of the wireless relay apparatuses 10b to 10d, and selects a wireless relay apparatus 10 which has a stable difference between the transmission time and the first reception time in the time sample (for example, wireless relay apparatus 10b) as a relay destination. Note that if a difference between a transmission time and a first reception time in a time sample is stable, a distance between the wireless relay apparatuses 10a and 10b is stable, for example, and it is an indication that the wireless relay apparatuses 10a and 10b are disposed in the same mobile object or mobile objects which move in cooperation. In such a structure, each wireless relay apparatus 10 does not require a sensor device such as GPS sensor (or an altimeter), and costs in introducing an IoT communication system can be reduced.

Note that, if the wireless relay apparatuses 10a to 10d use a wireless method conforming to IEEE 802.11, the first reception times may vary because of characteristics of a wireless access method. Thus, for example, a structure where NAV is set and ACK (signal) which has a promised transmission time is used may be adopted. Specifically, the wireless relay apparatus 10a transmits MSDU which is a base of ACK, and the wireless relay apparatuses 10b to 10d transmit ACK with respect to MSDU to the wireless relay apparatus 10a. Note that ACK transmitted from each of the wireless relay apparatuses 10b to 10d is received by the wireless relay apparatus 10a, and at that time, the wireless relay apparatus 10a samples a time when the ACK is received (hereinafter referred to as second reception time).

On the other hand, each of the wireless relay apparatuses 10b to 10d samples a time when MSDU is received from the wireless relay apparatus 10a (hereinafter referred to as third reception time), and object information including the sampled third reception time is transmitted from each of the wireless relay apparatuses 10b to 10d to the wireless relay apparatus 10a.

In that case, the wireless relay apparatus 10a compares the second reception time sampled by the wireless relay apparatus 10a with the third reception time included in the object information transmitted from each of the wireless relay apparatuses 10b to 10d, and a wireless relay apparatus 10 having a stabled difference between the second and third reception times (for example, wireless relay apparatus 10b) can be selected as a relay destination.

Furthermore, if the wireless relay apparatuses 10a to 10d of the present embodiment are provided with mobile objects such as mobile robots (for example, AGVs or the like) which move (run) as groups while changing routes during operation, for example, count values indicative of stability to the first wireless network 30 may be replaced with the above-mentioned movement vector (sample data thereof). Specifically, each of the wireless relay apparatuses 10a to 10d detects whether or not a radio wave strength (signal strength) from the wireless relay apparatus 10a is within a reception sensitivity (that is, a signal transmitted from the wireless relay apparatus 10a can be received), and activates a timer to increment at a certain periodical time if the strength is within the reception sensitivity. Thus, each of the wireless relay apparatuses 10b to 10d transmits object information including an average value of radio wave strength (reception field strength) of beacon signal or the like transmitted from the wireless relay apparatus 10a and a value counted thereof by the timer (count value) to the wireless relay apparatus 10a. The wireless relay apparatus 10a evaluates the average value of the radio wave strength and the count value included in the object information transmitted from each of the wireless relay apparatuses 10b to 10d in accordance with a certain algorithm to select a wireless relay apparatus 10 to be a relay destination (for example, wireless relay apparatus 10b). In that case, even if an average value of the radio wave strength is low, a wireless relay apparatus 10 of greater count value (that is, wireless relay apparatus 10 existing for a long time in a range which keeps the radio wave strength within a reception sensitivity) is selected with priority.

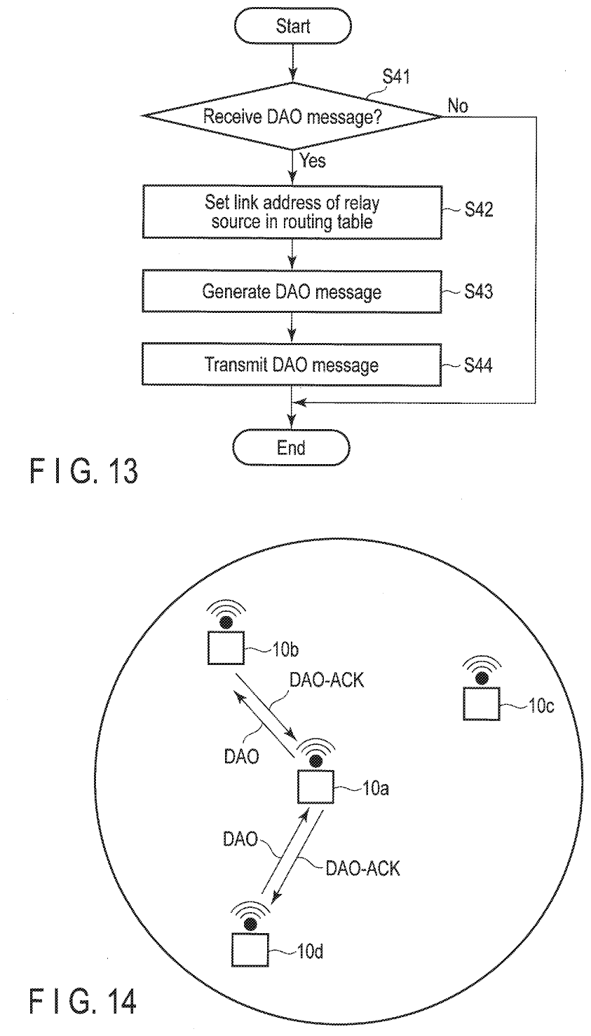

Now, an example of a process performed when a relay destination in a downstream direction is set in the wireless relay apparatus 10a will be explained with reference to a flowchart of FIG. 13.

Here, in the example of FIGS. 8 and 9, the wireless relay apparatus 10d is disconnected to the first wireless network 30, and when the wireless relay apparatus 10d forms the first wireless network 30, a process similar to that performed by the wireless relay apparatus 10a of FIG. 10 is performed by the wireless relay apparatus 10d. Thus, a case where in the wireless relay apparatus 10a is selected by the wireless relay apparatus 10d as a relay destination in the upstream direction will be considered. In that case, the wireless relay apparatus 10d generates a DAO message and transmits the DAO message (wireless relay frame including thereof) to the wireless relay apparatus 10a.

Note that, in a relay source address of a header field in a wireless relay frame transmitted from the wireless relay apparatus 10d, a link address of the wireless relay apparatus 10d is set.

The route management module 104 included in the wireless relay apparatus 10a determines whether or not a DAO message is received (step S41).

If it is determined that a DAO message is not received (NO in step S41), the process ends.

On the other hand, if it is determined that the DAO message is received (YES in step S41), the route management module 104 takes a link address of the wireless relay apparatus 10d set in a relay source address of a header field of a wireless relay frame including the DAO message in a case where the DAO message includes a link address of the wireless relay apparatus 10 which is a relay destination in the downstream direction of the wireless relay apparatus 10d. The link address of the wireless relay apparatus 10d (relay destination in the downstream direction) is set in the routing table 105 as a relay destination address with respect to the wireless relay apparatus 10 included in the DAO message (step S42).

When step S42 is executed, the route management module 104 generates a new DAO message (wireless relay frame) to which a link address of the wireless relay apparatus 10a is added (step S43).

The DAO message generated in step S43 is transmitted to a relay destination in the upstream direction of the wireless relay apparatus 10a (for example, wireless relay apparatus 10b) referring to the routing table 105 (step S44). Note that a link address of the wireless relay apparatus 10b is set in a relay destination address of a header field of a wireless relay frame including the DAO message.

Now, referring to FIG. 14, the wireless relay apparatus 10 set in the routing table 105 as the relay destination in the downstream will be explained. If the wireless relay apparatus 10d connects to the first wireless network 30 for the first time and the wireless relay apparatus 10a is selected as a relay destination in the upstream direction in the wireless relay apparatus 10d, the wireless relay apparatus 10d transmits a DAO message (wireless relay frame including the DAO message) to the wireless relay apparatus 10a.

When the wireless relay apparatus 10a receives a DAO message transmitted from the wireless relay apparatus 10d, the wireless relay apparatus 10a transmits a DAO-ACK message with respect to the wireless relay apparatus 10d.

Then, the wireless relay apparatus 10a generates a DAO message and transmits the DAO message to the wireless relay apparatus 10b which is a relay destination in the upstream direction set in the routing table 105. In the DAO message, a link address of the wireless relay apparatus 10a is added to the link address of the wireless relay apparatus 10d included in the received DAO message in the wireless relay apparatus 10a.

When the wireless relay apparatus 10b receives the DAO message transmitted from the wireless relay apparatus 10a, the wireless relay apparatus 10b transmits a DAO-ACK message to the wireless relay apparatus 10a.

Note that, although this is not shown in FIG. 14, the wireless relay apparatus 10b further transmits a DAO message in which the link address of the wireless relay apparatus 10b is added to the link addresses of the wireless relay apparatuses 10a and 10d included in the DAO message received by the wireless relay apparatus 10b to the relay destination in the upstream direction of the wireless relay apparatus 10b (that is, the relay destination in the upstream direction set in the routing table 105 of the wireless relay apparatus 10b).

In the present embodiment, the DAO message transmitted from the wireless relay apparatus 10 (for example, the wireless relay apparatus 10d) is relayed by the wireless relay apparatuses 10 forming the first wireless network 30 while adding the link addresses in the DAO message, and finally reaches to the gateway 20, and is transmitted to the server 60 through the second wireless network 50 and the fixed wireless apparatus 40. The DAO message is used in the server 60 as route information which will be described later. In this example, the DAO message has been explained; however, object information transmitted from each wireless relay apparatus 10 (DIO message) may be transmitted to the server 60 through wireless relay apparatuses 10, gateway 20, and fixed wireless apparatus 40.

Note that, in the present embodiment, the process of setting the routing table 105 (process shown in FIGS. 10 and 13) is performed at the time when the wireless relay apparatus 10 connects to the first wireless network 30 for the first time, and a setting environment of the wireless relay apparatus 10 may change. Specifically, for example, if the wireless relay apparatuses 10 are disposed in a train and another train are added to the train, a route (relay destination) is, preferably, reselected. Thus, the process corresponding to the process of FIGS. 10 and 13 is periodically executed even if a relay destination (relay destination in an upstream direction and relay destination in a downstream direction) is once set in the routing table 105.

Furthermore, as described above, the server 60 can collect (receive) route information and object information, and the reselection of route may be instructed by the server 60 using such information. In the following explanation, route information and object information collected by the server 60 will be referred to as network information related to the first wireless network 30 formed of the gateway 20 which transmit such information.

Now, the structure of the server 60 of the present embodiment will be explained. Note that although the hardware structure of the server 60 is not shown, the server 60 includes, for example, a hardware processor (processor circuitry), nonvolatile memory, main memory, and communication device as with the wireless relay apparatus 10 shown in FIG. 5.

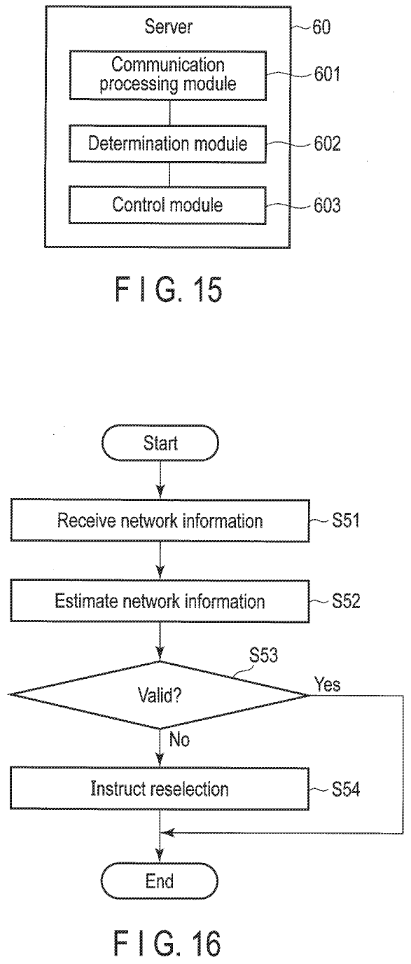

FIG. 15 is a block diagram illustrating an example of the functional structure of the server 60. As in FIG. 15, the server 60 includes a communication processing module 601, determination module 602, and control module 603.

In the present embodiment, all or a part of the communication processing module 601, determination module 602, and control module 603 will be implemented by causing the processor to execute a certain program (application program), that is, implemented by software.

Note that all or a part of the modules 601 to 603 may be implemented by hardware or may be implemented as a combination of software and hardware.

Furthermore, although this is omitted from FIG. 15, the server 60 includes the above-mentioned address table. The address table may be stored in a nonvolatile memory or the like.

Hereinafter, an example of a process performed by the server 60 when reselection of route is instructed will be explained with reference to FIG. 16.

Firstly, the communication processing module 601 receives network information (route information and object information) related to the first wireless network 30 (hereinafter referred to as target first wireless network 30) (step S51).

Note that, when step S51 is executed, the server 60 identifies an identifier of the first wireless network 30 related to a subscriber identification number of the gateway 20 which transmits the network information by referring to the address table, and maintains the network information received in step S51 associated with the identifier of the first wireless network 30.

Then, the determination module 602 estimates the network information related to the target first wireless network 30 from application program operable on the server 60 (application program to collect sensor data measured by various sensors and to control operation of the sensors) (step S52).

The determination module 602 compares the network information received in step S51 with network information estimated in step S52 to determine whether or not the first wireless network 30 is valid (that is, credibility of the target first wireless network 30) (step S53).

Specifically, in a case where the number of wireless relay apparatuses 10 controlled under the gateway 20 forming the target first wireless network 30 is determined to be, for example, ten on the application program operable on the server 60 (that is, network information estimated in step S52), if the number of the wireless relay apparatuses 10 based on the network information transmitted from the gateway 20 is other than ten, the determination module 602 estimates that the target first wireless network 30 is in a state before convergence, and the target first wireless network 30 is determined to be invalid.

If the target first wireless network 30 is determined to be invalid (NO in step S53), the control module 603 instructs, for example, the gateway 20 forming the target first wireless network 30 (or the wireless relay apparatus 10) to reselect the route of the target first wireless network 30 (step S54).

When step S54 is executed, a process corresponding to the process shown in FIGS. 10 and 13 is executed in the wireless relay apparatuses 10 forming the target first wireless network 30, and a relay destination (route) set in the routing table 105 of each wireless relay apparatus 10 is reselected. Note that, when step S54 is executed, the operation of application program executed on the server 60 with respect to the target first wireless network 30 (service provision based on the application program and the like) may be limited.

Through the process shown in FIG. 16, if the target first wireless network 30 is determined to be invalid, the reselection of route in the first wireless network 30 (that is, reformation of first wireless network 30) can be instructed.

Note that, if the object information includes a RANK value, the number of relays (hops) from the gateway 20 to the wireless relay apparatus 10 to which the RANK value is added (that is, the wireless relay apparatus 10 which transits the object information) can be estimated. By combining the number of relays and sample data of movement vector included in the object information (positional information), a structure to estimate a wireless relay apparatus 10 connected to a specific sensor (sensor disposed in a specific device or a specific facility) and to transmit application control data to the wireless relay apparatus 10 may be adopted.

As described above, in the present embodiment, for example, the wireless relay apparatus 10a (electronic apparatus) configured to communicate with the wireless relay apparatuses 10b and 10c (first and second wireless relay apparatuses) acquires a movement direction and a movement speed (movement vector) of the wireless relay apparatuses 10a to 10c and selects a relay destination (connection destination) of data (sensor data or application control data) transmitted from the wireless relay apparatus 10a based on the movement direction and the movement speed.

Specifically, a similarity (first similarity) between the movement vector of the wireless relay apparatus 10a and the movement vector of the wireless relay apparatus 10b is calculated and a similarity (second similarity) between the movement vector of the wireless relay apparatus 10a and the movement vector of the wireless relay apparatus 10c is calculated, and if the first similarity is higher than the second similarity, the wireless relay apparatus 10b is selected as a relay destination, and if the second similarity is higher than the first similarity, the wireless relay apparatus 10c is selected as a relay destination.

If the wireless relay apparatus 10b is selected as a relay destination, the wireless relay apparatus 10a and the wireless relay apparatus 10b form the first wireless network 30 (wireless mesh network), and a link address of the wireless relay apparatus 10b is set in the routing table 105 included in the wireless relay apparatus 10a. On the other hand, if the wireless relay apparatus 10c is selected as a relay destination, the wireless relay apparatus 10a and the wireless relay apparatus 10c form the first wireless network 30 (wireless mesh network), and a link address of the wireless relay apparatus 10c is set in the routing table 105 included in the wireless relay apparatus 10a.

Here, if a plurality of wireless relay apparatuses 10 are disposed in a plurality of trains, if a wireless relay apparatus 10c which is in a train different from a train in which a wireless relay apparatus 10a is disposed is selected as a relay destination, communication between the wireless relay apparatuses 10a and 10c becomes impossible because of the movement of the train, and a relay destination of data transmitted from the wireless relay apparatus 10a must be selected repeatedly.

In contrast, according to the structure of the present embodiment, as a relay destination of the data transmitted from the wireless relay apparatus 10a, for example, a wireless relay apparatus 10b disposed in the same train as the wireless relay apparatus 10a (that is, wireless relay apparatus 10b moves in the same direction at the same speed as the wireless relay apparatus 10a) is selected, and thus, the frequency of the route selection of the relay destinations can be reduced, and a first wireless network 30 with high stability can be achieved.

In this example, a plurality of wireless relay apparatuses 10 (and sensors) are disposed in a train, and the same applies to a case where a wireless relay apparatus 10 is disposed in each of mobile objects and the mobile objects operate in cooperation.

Furthermore, in the present embodiment, in consideration of a possibility that an environment or the like in which the wireless relay apparatus 10a is disposed changes, a relay destination of the wireless relay apparatus 10a may reselected regularly after the formation of the first wireless network 30. In such a structure, the stability of the first wireless network 30 formed by the wireless relay apparatus 10a can be maintained.

Furthermore, in the present embodiment, sensor data measured by sensors connected to the wireless relay apparatus 10a are transmitted to the gateway 20 through the wireless relay apparatus 10a and the wireless relay apparatus 10b selected as a relay destination. Furthermore, the gateway 20 transmits sensor data to the server 60 through the second wireless network 50 including the gateway 20 and the fixed wireless apparatus 40.

With the above-mentioned structure, the server 60 can collect sensor data measured by sensors connected to the wireless relay apparatuses 10 through the stable first wireless network 30. Thus, various services can be provided using the sensor data.

Note that, if the wireless relay apparatus 10b is selected as a relay destination of data transmitted from the wireless relay apparatus 10a, the wireless relay apparatus 10a and the wireless relay apparatus 10b form the first wireless network 30, and in that case, a wireless relay apparatus 10c which is not selected as a relay destination of data transmitted from the wireless relay apparatus 10a forms a first wireless network 30 which is different from the first wireless network 30. With such a structure, the server 60 can collect sensor data measured by sensors connected to the wireless relay apparatus 10c through the different first wireless network 30.

Furthermore, in the present embodiment, the server 60 receives network information (route information and object information) related to the first wireless network 30, and if the first wireless network 30 is determined to be invalid based on the received network information and the application program operable on the server 60 to collect the sensor data, the server 60 instructs the reformation of the first wireless network 30 (that is, reselection of route).

With such a structure of the present embodiment, even if the first wireless network 30 is formed, a current condition of the first wireless network 30 can be compared with a condition estimated based on the application program (that is, optimal performance of the first wireless network 30), and thus, the credibility (validity) of the first wireless network 30 can be monitored.

Furthermore, in the present embodiment, the server 60 can be structured to estimate a wireless relay apparatus 10 connected to a certain (specific) sensor from wireless relay apparatuses 10 based on the network information.

With such a structure, for example, in controlling the operation of sensors disposed in a specific device or facility of a train, for example, even if a correspondence (connection relationship) between the sensors and the wireless relay apparatuses 10 is unknown, the operation of a specific sensor can be controlled by transmitting application control data with respect to a wireless relay apparatus 10 which is specified as a fifth apparatus counted from the gateway 20 forming the first wireless network 30, for example. That is, in the present embodiment, a specific sensor (wireless relay apparatus 10 connected thereto) can be estimated with high accuracy without applying a unique ID to the sensors in the application program operable on the server 60.

In this example, a wireless relay apparatus 10 connected to a specific sensor is estimated. However, if each wireless relay apparatus 10 is disposed in different mobile objects, a wireless relay apparatus 10 connected to a specific mobile object may be estimated, and the specific mobile object may be controlled.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus configured to communicate with a first wireless relay apparatus and a second wireless relay apparatus, the electronic apparatus comprising:
processor circuitry configured to:
acquire information regarding a movement direction and a movement speed of the electronic apparatus;
acquire information regarding a movement direction and a movement speed of the first wireless relay apparatus;
acquire information regarding a movement direction and a movement speed of the second wireless relay apparatus; and
select a relay destination of data from the first wireless relay apparatus and the second wireless relay apparatus based on the movement direction and the movement speed of the electronic apparatus, the movement direction and the movement speed of the first wireless relay apparatus, and the movement direction and the movement speed of the second wireless relay apparatus; and
transmission circuitry configured to transmit the data to selected one of the first wireless relay apparatus and the second wireless relay apparatus.

2. The electronic apparatus of claim 1, wherein the first wireless relay apparatus and the electronic apparatus are comprised in the same mobile object, and the second wireless relay apparatus and the electronic apparatus are comprised in different mobile objects.

3. The electronic apparatus of claim 1, wherein at least one of the information regarding the movement direction and the movement speed of the electronic apparatus, the information regarding the movement direction and the movement speed of the first wireless relay apparatus, and the information regarding the movement direction and the movement speed of the second wireless relay apparatus are information generated based on absolute values of the movement direction and the movement speed.

4. The electronic apparatus of claim 1, wherein at least one of the information regarding the movement direction and the movement speed of the first wireless relay apparatus and the information regarding the movement direction and the movement speed of the second wireless relay apparatus are information generated based on relative values of the movement direction and the movement speed with respect to the movement direction and the movement speed of the electronic apparatus.

5. The electronic apparatus of claim 1, wherein the processor circuitry is configured to:
select the first wireless relay apparatus as the relay destination if a first similarity between the movement direction and the movement speed of the electronic apparatus and the movement direction and the movement speed of the first wireless relay apparatus is higher than a second similarity between the movement direction and the movement speed of the electronic apparatus and the movement direction and the movement speed of the second wireless relay apparatus, and
select the second wireless relay apparatus as the relay destination if the second similarity is higher than the first similarity.

6. The electronic apparatus of claim 5, further comprising a routing table, wherein,
if the first wireless relay apparatus is selected as the relay destination, the electronic apparatus and the first wireless relay apparatus form a wireless network, and an address of the first wireless relay apparatus is set in the routing table, and
if the second wireless relay apparatus is selected as the relay destination, the electronic apparatus and the second wireless relay apparatus form a wireless network, and an address of the second wireless relay apparatus is set in the routing table.

7. The electronic apparatus of claim 6, wherein the processor circuitry is configured to reselect a relay destination of data transmitted from the transmission circuitry after the wireless network is formed.

8. A system comprising:
the electronic apparatus of claim 1;
the selected wireless relay apparatus; and
a gateway, wherein
the electronic apparatus is connected to a sensor, and data measured by the sensor are transmitted to the gateway through the electronic apparatus and the selected wireless relay apparatus.

9. The system of claim 8, further comprising a server, wherein
the gateway is configured to transmit the data measured by the sensor to the server.

10. The system of claim 9, wherein the electronic apparatus, selected wireless relay apparatus, and gateway form a first wireless network, and
the wireless relay apparatus other than the selected wireless relay apparatus forms a first wireless network different from the first wireless network.

11. The system of claim 10, further comprising a fixed wireless apparatus configured to communicate with a gateway forming each of the first wireless networks and to be connected to the server in a communicable manner, wherein
the fixed wireless apparatus forms a second wireless network different from the first wireless networks with the gateway forming each of the first wireless networks.

12. A server configured to collect data transmitted through a wireless network formed of a plurality of wireless relay apparatuses, the server comprising:
processor circuitry configured to:
receive network information regarding the wireless network through the wireless network;
determine whether or not the wireless network is valid based on the received information and an application program which operates on the server to collect the data; and
instruct reformation of the wireless network if the wireless network is determined to be invalid.

13. The server of claim 12, wherein
each of the wireless relay apparatuses is connected to a sensor to measure the data, and
the processor circuitry is configured to estimate, based on the network information, a wireless relay apparatus connected to a specific sensor of the wireless relay apparatuses.

14. A method executed by an electronic apparatus configured to communicate with a first wireless relay apparatus and a second wireless relay apparatus, the method comprising:
acquiring information regarding a movement direction and a movement speed of the electronic apparatus;
acquiring information regarding a movement direction and a movement speed of the first wireless relay apparatus;
acquiring information regarding a movement direction and a movement speed of the second wireless relay apparatus;
selecting a relay destination of data from the first wireless relay apparatus and the second wireless relay apparatus based on the movement direction and the movement speed of the electronic apparatus, the movement direction and the movement speed of the first wireless relay apparatus, and the movement direction and the movement speed of the second wireless relay apparatus; and
transmitting the data to selected one of the first wireless relay apparatus and the second wireless relay apparatus.
